(19) United States
(12) Patent Application Publication
(10) Pub. No.: US 2026/0266990 A1
(43) Pub. Date: Sep. 10, 2026

(54) METHOD AND SYSTEM FOR INTEGRATED MEASUREMENT OF HYDROLOGICAL ELEMENTS IN HIGH-SALINITY AND HIGH-SEDIMENT ENVIRONMENT

(71) Applicant: CHINA THREE GORGES UNIVERSITY, Yichang City (CN)

(72) Inventors: Changwen LI, Yichang City (CN); Feihan LI, Yichang City (CN); Yuxin XIE, Yichang City (CN); Jiaqi ZHU, Yichang City (CN); Haoxiong ZHAN, Yichang City (CN); Zhiwei LI, Yichang City (CN); Xiaolei LV, Yichang City (CN); Shuyun DU, Yichang City (CN); Chenxue GONG, Yichang City (CN); Jiale HUANG, Yichang City (CN); Sujing LIN, Yichang City (CN); Rui ZHOU, Yichang City (CN); Liting YANG, Yichang City (CN); Yang YI, Yichang City (CN); Ziye SHENG, Yichang City (CN); Shijie JIN, Yichang City (CN); Yujia HUANG, Yichang City (CN); Ye HUANG, Yichang City (CN); Ziyang ZOU, Yichang City (CN)

(21) Appl. No.: 19/429,280

(22) Filed: Dec. 22, 2025

(30) Foreign Application Priority Data
Mar. 7, 2025 (CN) 202510272357.3

(51) Int. Cl. G01S 15/89; G01C 13/00; G01S 7/52; G01S 15/08

(52) U.S. Cl. CPC G01S 15/89; G01C 13/00; G01S 7/52003; G01S 15/08

(57) ABSTRACT

Provided is a method and system for integrated measurement of hydrological elements in a high-salinity and high-sediment environment. When the method is utilized to measure an underwater topography, theoretical received signal strengths of sonars are corrected using an established acoustic attenuation model and then effective signal-to-noise ratios are calculated, whereby data fusion is performed on water depth data of the sonars. Moreover, iterative optimization is performed on model parameters. High accuracy is achieved. When the method is utilized to measure a water flow velocity and a flow rate, iterative decoupling is performed based on a comprehensive sediment particle movement model to obtain a sediment particle velocity. The water flow velocity is then updated based on a difference between the measured apparent velocity and the sediment particle velocity. Once the updated water flow velocity converges, the accurate water flow rate can be calculated in combination with a discharge section area.

### CROSS REFERENCE TO RELATED APPLICATION

This patent application claims the benefit and priority of Chinese Patent Application No. 2025102723573, filed with the China National Intellectual Property Administration on Mar. 7, 2025, the disclosure of which is incorporated by reference herein in its entirety as part of the present application.

### TECHNICAL FIELD

The present application relates to the technical field of hydrological monitoring, and in particular, to a method and system for integrated measurement of hydrological elements in a high-salinity and high-sediment environment.

### BACKGROUND

Currently, hydrological monitoring of inland rivers primarily relies on advanced equipment such as acoustic Doppler current profilers, echo sounders, and optical backscatter turbidity meters mounted on unmanned surface vehicles. However, in highly sediment-laden rivers within saline and alkaline regions like Xinjiang, since the water salinity (which can reach as high as 5-15‰) and the sediment concentration (which exceeds 50 kg/m³ during flood seasons) are significantly higher than those in conventional freshwater rivers, and acoustic signal attenuation is substantially interfered with. Firstly, deviations in acoustic velocity calculations due to salinity variations (traditional algorithms default to an acoustic velocity of 1500 m/s in freshwater) lead to systematic errors in water depth measurements. Secondly, traditional single-frequency sonars lack sufficient penetration capability in highly sediment-laden water. Sediment particles cause intensified acoustic wave scattering and absorption, resulting in virtual images or data loss in topographic surveys. Furthermore, relying solely on the linear relationship between turbidity and sediment concentration leads to significant differences in acoustic wave scattering characteristics across different rivers, and without sediment particle size distribution parameters introduced, errors may increase. Moreover, multi-parameter coupling interference is not decoupled, and existing flow measurement algorithms fail to account for the multi-physical field coupling effects of salinity, temperature, and turbidity: salt ions alter water conductivity, affecting the accuracy of electromagnetic flowmeters; in addition, high sediment concentrations cause Doppler current profilers to misinterpret particle movements as water flow velocities.

Thus, low measurement accuracy severely restricts the fulfillment of national strategic needs, such as hydro-ecological monitoring in arid regions and water resource scheduling in irrigation districts. Confronted with these challenges, how to achieve rapid and accurate measurement of hydrological elements in a high-salinity and high-sediment environment has become a critical issue.

### SUMMARY

An objective of the present application is to provide a method and system for integrated measurement of hydrological elements in a high-salinity and high-sediment environment, enabling rapid and accurate measurement of hydrological elements in the high-salinity and high-sediment environment.

To achieve the above objective, the present application provides the following technical solutions.

In a first aspect, the present application provides a method for integrated measurement of hydrological elements in a high-salinity and high-sediment environment, which is used to accurately measure an underwater topography in the high-salinity and high-sediment environment using an unmanned surface vehicle equipped with a plurality of measuring instruments and includes the following steps:
establishing an acoustic attenuation model for a laser particle size analyzer and a multi-frequency sonar group carried by the unmanned surface vehicle, where the multi-frequency sonar group includes a plurality of sonars with different frequencies; and the acoustic attenuation model is configured to characterize respective attenuations of acoustic waves emitted by the sonars with different frequencies at different sediment concentrations;
correcting theoretical received signal strengths of the sonars using the acoustic attenuation model and an acoustic wave propagation distance, thereby obtaining corrected theoretical received signal strengths of the sonars;
performing time synchronization and space registration on water depth data of the sonars, and calculating effective signal-to-noise ratios of the sonars based on the corrected theoretical received signal strengths of the sonars;
performing data fusion on the water depth data of the sonars by using a dynamic weight fusion algorithm based on the effective signal-to-noise ratios of the sonars so as to obtain fused water depth data, where the water depth data is water depth data measured after calibrating velocities of the acoustic waves emitted by the sonars with a salinity, a water temperature, and a turbidity; and
performing iterative optimization on parameters of the acoustic attenuation model using an inversion method based on residual minimization according to residual values between actual received signal strengths and the theoretical received signal strengths of the sonars, thereby achieving dynamic parameter adjustment in a complex environment where the salinity and the sediment concentration change dynamically.

Optionally, the acoustic attenuation model is expressed as follows:

$$α ( f ) = k \cdot {C}^{m} \cdot {f}^{d} \cdot {d}^{p} ;$$

where α(f) represents an acoustic attenuation coefficient of a sonar with an acoustic wave frequency f, k represents a water attenuation proportion coefficient; C represents a sediment concentration; m represents a sediment concentration index; f represents an acoustic wave frequency; n represents a frequency index; d represents a sediment particle size; and p represents a particle size index;
the theoretical received signal strength of any of the sonars is corrected by a formula below:

$${P}_{s i g n a l} ( f ) = {P}_{t x} \cdot \frac{{e}^{- 2 α ( f , C , d ) \cdot D}}{{A}_{eff}} \cdot R ;$$

where P_{signal}(f) represents the corrected theoretical received signal strength of the sonar with the acoustic wave frequency f, Pₜₓ represents a sonar transmission power; e represents a natural constant; D represents a water depth at a position where the unmanned surface vehicle is located; A_{eff} represents an effective irradiation area of a sonar wave beam; and R represents a riverbed reflection coefficient at the position where the unmanned surface vehicle is located.

Optionally, the performing data fusion on the water depth data of the sonars by using a dynamic weight fusion algorithm based on the effective signal-to-noise ratios of the sonars so as to obtain fused water depth data specifically includes the following steps:
for a sonar with an effective signal-to-noise ratio higher than a second threshold, setting a weight of the sonar to 0;
for sonar with the effective signal-to-noise ratio higher than the first threshold, setting the weight of the sonar to 1;
for a sonar with an effective signal-to-noise ratio higher than a first threshold and lower than the second threshold, calculating a weight of the sonar according to a proportion of the effective signal-to-noise ratio of the sonar in a sum of the effective signal-to-noise ratios of the sonars; and
calculating the fused water depth data according to the weights of the sonars and the water depth data of the sonars.

Optionally, the effective signal-to-noise ratio of any of the sonars is calculated by a formula below:

$$S N R ( f ) = 10 {log}_{10} ( \frac{{P}_{signal} ( f )}{{P}_{n o i s e} ( f )} ) ;$$

where SNR(f) represents the effective signal-to-noise ratio of the sonar with the acoustic wave frequency f, P_{signal}(f) represents the corrected theoretical received signal strength of the sonar with the acoustic wave frequency f, and Pₙₒᵢₛₑ(f) represents background noise energy of the sonar with the acoustic wave frequency f,
when the multi-frequency sonar group includes only one high-frequency sonar and one low-frequency sonar, the fused water depth data is calculated by a formula below:

$${H}_{f u s e d} = {w}_{l o w} \cdot {H}_{l o w} + {w}_{h i g h} \cdot {H}_{h i g h} ;$$

where H_{fused} represents the fused water depth data; w_{low} represents a weight of the low-frequency sonar; H_{low} represents the water depth data of the low-frequency sonar; w_{high} represents a weight of the high-frequency sonar; and H_{high} represents the water depth data of the high-frequency sonar.

Optionally, the performing iterative optimization on parameters of the acoustic attenuation model using an inversion method based on residual minimization according to residual values between actual received signal strengths and the theoretical received signal strengths of the sonars specifically includes the following steps:
for any of the sonars, calculating the theoretical received signal strength of the sonar according to a current acoustic attenuation coefficient;
calculating a received signal strength residual according to the actual received signal strength and the theoretical received signal strength of the sonar;
iteratively optimizing the acoustic attenuation coefficient using a gradient descent method based on a partial derivative of the square of the received signal strength residual with respect to the acoustic attenuation coefficient until a difference between the current acoustic attenuation coefficient and a previous acoustic attenuation coefficient is smaller than a convergence threshold, thereby obtaining a target acoustic attenuation coefficient; and
re-calibrating the parameters of the acoustic attenuation model based on the target acoustic attenuation coefficient, thereby realizing dynamic updating of the acoustic attenuation model.

Optionally, the velocities of the acoustic waves emitted by the sonars are calibrated by a formula below:

$$c = 1449.2 + 4.6 T - 0.055 {T}^{2} + 0.0003 {T}^{3} + ( 1.34 - 0.01 T ) ( S - 35 ) + 0.016 D ;$$

where c represents a calibrated acoustic wave velocity of a sonar; T represents a water temperature measured at the position where the unmanned surface vehicle is located; S represents a salinity measured at the position where the unmanned surface vehicle is located; and D represents the water depth at the position where the unmanned surface vehicle is located.

In a second aspect, the present application further provides a method for integrated measurement of hydrological elements in a high-salinity and high-sediment environment, which is used to accurately measure a water flow velocity and a flow rate in the high-salinity and high-sediment environment using an unmanned surface vehicle equipped with a plurality of measuring instruments and includes the following steps:
aligning timestamps and spatial positions of the plurality of measuring instruments carried by the unmanned surface vehicle to achieve time synchronization and space registration of various types of measurement data, where the measuring instruments carried by the unmanned surface vehicle include an electromagnetic flow meter, a radar current meter, a laser particle size analyzer, and a corrosion-resistant acoustic Doppler current profiler;
iteratively decoupling a sediment particle velocity according to a water flow velocity measured by the electromagnetic flow meter and based on a comprehensive sediment particle movement model to obtain the sediment particle velocity;
calculating an updated water flow velocity based on an apparent velocity measured by the corrosion-resistant acoustic Doppler current profiler and the sediment particle velocity;
determining whether the updated water flow velocity converges based on a comparison of a difference between the updated water flow velocity and a surface flow velocity measured by the radar current meter with a water flow velocity error threshold;
if the updated water flow velocity does not converge, optimizing parameters of the comprehensive sediment particle movement model, and iteratively decoupling the sediment particle velocity according to the water flow velocity measured by the electromagnetic flow meter and based on the comprehensive sediment particle movement model to obtain the sediment particle velocity; and
if the updated water flow velocity converges, correcting the water flow velocity based on the measured salinity, and calculating a water flow rate based on the corrected water flow velocity with the salinity and a discharge section area.

Optionally, the comprehensive sediment particle movement model is expressed as follows:

$${v}_{s}^{( n )} = {v}_{w}^{( n )} \cdot ( 1 - {e}^{- K \cdot \frac{{ρ}_{s} - {ρ}_{w}}{{ρ}_{w}} \cdot {d}^{0.5}} ) + {I}_{t} \cdot {v}_{w}^{( n )} \cdot \sqrt{\frac{{ρ}_{w}}{{ρ}_{s}}} ;$$

where

$${v}_{s}^{( n )}$$

represents a sediment particle velocity during n-th iterative decoupling;

$${v}_{w}^{( n )}$$

represents a water flow velocity during the n-th iterative decoupling; K represents a concentration attenuation coefficient; ρₛ and ρ_{w} represent densities of sediment and water, respectively; d represents the sediment particle size; and Iₜ represents a turbulence intensity; and
the updated water flow velocity is calculated by a formula as follows:

$${v}_{w}^{( n + 1 )} = {v}_{ADCP} - {v}_{s}^{( n )} ;$$

where

$${v}_{w}^{( n + 1 )}$$

represents the updated water flow velocity; and v_{ADCP} represents the apparent velocity measured by the corrosion-resistant acoustic Doppler current profiler.

Optionally, the water flow velocity is corrected by a formula as follows:

$${v}_{E M , c o r rected} = {v}_{E M} \cdot ( 1 + β \cdot ( S - {S}_{0} ) ) ;$$

where v_{EM,corrected} represents the corrected water flow velocity with the salinity; v_{EM} represents the water flow velocity measured by the electromagnetic flow meter; β represents a salinity sensitivity coefficient; S represents the measured salinity; and S₀ represents a calibrated salinity.

In a third aspect, the present application provides a system for integrated measurement of hydrological elements in a high-salinity and high-sediment environment, which has an unmanned surface vehicle of a sediment deposition-preventing structure as a main body and includes: a platform adaptation module that is configured to provide hardware support for the unmanned surface vehicle and includes a titanium alloy sensor housing, a salt-spray-proof electronic compartment, a propeller equipped with a protective net, and a positioning unit; an environmental perception module including a plurality of measuring instruments carried by the unmanned surface vehicle; a data processing module configured to implement the method for integrated measurement of hydrological elements in a high-salinity and high-sediment environment as described above; and an energy source and communication module configured to provide energy and power for the unmanned surface vehicle and provide support for communication between modules.

According to specific embodiments provided in the present application, the present application has the following technical effects.

The present application provides a method and system for integrated measurement of hydrological elements in a high-salinity and high-sediment environment. When this solution is utilized to measure the underwater topography in the high-salinity and high-sediment environment, the acoustic attenuation model is established for the multi-frequency sonar group carried by the unmanned surface vehicle; the theoretical received signal strengths of the sonars are corrected using the acoustic attenuation model and then the effective signal-to-noise ratios are calculated, whereby data fusion is performed on the water depth data of the sonars using the dynamic weight fusion algorithm based on the obtained effective signal-to-noise ratios to obtain the fused water depth data. High accuracy is achieved. Moreover, in practical use, the residuals between the actual received signal strengths and the theoretical values are further provided, and iterative optimization is performed on the parameters of the acoustic attenuation model using the inversion method based on residual minimization. When this solution is utilized to measure the water flow velocity and the flow rate in the high-salinity and high-sediment environment, iterative decoupling is performed on the sediment particle velocity based on the comprehensive sediment particle movement model to obtain the sediment particle velocity. The water flow velocity is then updated based on the difference between the apparent velocity measured by the corrosion-resistant acoustic Doppler current profiler and the sediment particle velocity. Once the updated water flow velocity converges, the accurate water flow rate can be calculated in combination with the discharge section area. The aforesaid solutions described in the present application employ multi-frequency sonar measurements and utilize the acoustic attenuation model to establish a dynamic sonar weight allocation mechanism. This achieves the fusion of multi-frequency sonar data, resolving the conflict between penetration capability and resolution in highly turbid water. Furthermore, the acoustic attenuation coefficient is inverted from the residuals between the measured received signal strengths and the theoretical values, enabling dynamic parameter adjustment and thereby enhancing measurement accuracy. Furthermore, a sediment flow velocity decoupling measurement technique is constructed through cross-validation by multiple sensors, enabling accurate flow rate measurement in a riverway where the unmanned surface vehicle is deployed. The accuracy of underwater topography and sediment measurement by the unmanned surface vehicle in saline-alkali regions can be improved, providing a more accurate and practical solution for hydro-ecological monitoring in arid regions and water resource scheduling in irrigation districts.

### BRIEF DESCRIPTION OF THE DRAWINGS

To describe the technical solutions in the embodiments of the present application or in the related art more clearly, the following briefly describes the accompanying drawings required for describing the embodiments or the related art. Apparently, the accompanying drawings in the following description show some embodiments of the present application, and a person of ordinary skill in the art may still derive other accompanying drawings from these accompanying drawings without creative efforts.

FIG. 1 is a flowchart of a method for integrated measurement of hydrological elements in a high-salinity and high-sediment environment provided by an embodiment of the present application;

FIG. 2 is a flowchart of a method for integrated measurement of hydrological elements in a high-salinity and high-sediment environment provided by another embodiment of the present application;

FIG. 3 is a schematic diagram of an unmanned surface vehicle measuring a water flow velocity and a flow rate in a high-salinity and high-sediment environment in a method for integrated measurement of hydrological elements in a high-salinity and high-sediment environment provided by another embodiment of the present application; and

FIG. 4 is a schematic diagram of functional modules of a system for integrated measurement of hydrological elements in a high-salinity and high-sediment environment provided by an embodiment of the present application.

### DETAILED DESCRIPTION OF THE EMBODIMENTS

The technical solutions in the embodiments of the present application are clearly and completely described below with reference to the drawings in the embodiments of the present application. Apparently, the described embodiments are only some rather than all of the embodiments of the present application. All other embodiments derived from the embodiments in the present application by a person of ordinary skill in the art without creative efforts should fall within the protection scope of the present application.

To make the above objective, features, and advantages of the present application more obvious and easier to understand, the present application will be further described in detail with reference to the accompanying drawings and specific implementations.

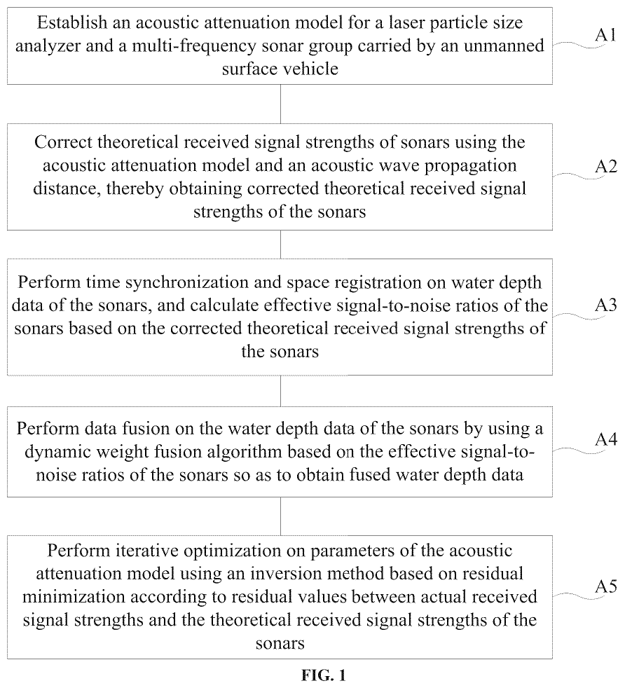

An embodiment of the present application provides a method for integrated measurement of hydrological elements in a high-salinity and high-sediment environment. In an exemplary embodiment, the method is used to accurately measure an underwater topography in the high-salinity and high-sediment environment using an unmanned surface vehicle equipped with a plurality of measuring instruments and, as shown in FIG. 1, includes the following steps.

In step A1, an acoustic attenuation model established for a laser particle size analyzer and a multi-frequency sonar group carried by the unmanned surface vehicle, where the multi-frequency sonar group includes a plurality of sonars with different frequencies; and the acoustic attenuation model is configured to characterize respective attenuations of acoustic waves emitted by the sonars with different frequencies at different sediment concentrations.

For a laser particle size analyzer and a multi-frequency sonar group carried by the unmanned surface vehicle, the backscattered signal strength decreases due to significant acoustic wave scattering attenuation caused by a high sediment concentration. By providing a turbidity sensor and the laser particle size analyzer to measure a suspended matter concentration in real time, the acoustic attenuation model is established to quantify the attenuations with different frequencies under different sediment concentrations, thereby guiding the selection of an optimal frequency combination for adjusting the weights. The sonar transmission frequency is adjusted to compensate for signal loss. Specifically in this embodiment, the acoustic attenuation model is expressed as follows:

$$α ( f ) = k \cdot {C}^{m} \cdot {f}^{n} \cdot {d}^{p} ;$$

where α(f) represents an acoustic attenuation coefficient of a sonar with an acoustic wave frequency f, k represents a water attenuation proportion coefficient, reflecting the total influence of water characteristics on attenuation; C represents a sediment concentration; m represents a sediment concentration index, depicting nonlinear influence of the sediment concentration C on attenuation; f represents an acoustic wave frequency; n represents a frequency index, depicting nonlinear influence of the acoustic wave frequency f on attenuation; d represents a sediment particle size; and p represents a particle size index, depicting nonlinear influence of the sediment particle size d on attenuation. Experimental calibration of k, m, n, and p is provided to avoid relying solely on the linear relationship between turbidity and sediment concentration. By introducing sediment particle size distribution parameters, the measurement accuracy of the sediment model is improved.

In step A2, theoretical received signal strengths of the sonars are corrected using the acoustic attenuation model and an acoustic wave propagation distance, thereby obtaining corrected theoretical received signal strengths of the sonars. To eliminate the energy loss of acoustic waves in the propagation path and restore the true reflection intensity and received signal strength for accurate calculation, the theoretical received signal strength P_{signal}(f) is corrected using the attenuation coefficient α(f) and the propagation distance D. Specifically, the theoretical received signal strength of any sonar is corrected by the following formula:

$${P}_{signal} ( f ) = {P}_{tx} \cdot \frac{{e}^{- 2 α ( f , C , d ) \cdot D}}{{A}_{eff}} \cdot R ;$$

where P_{signal}(f) represents the corrected theoretical received signal strength of the sonar with the acoustic wave frequency f, Pₜₓ represents a sonar transmission power; e represents a natural constant; D represents a water depth at a position where the unmanned surface vehicle is located; A_{eff} represents an effective irradiation area of a sonar wave beam; and R represents a riverbed reflection coefficient at the position where the unmanned surface vehicle is located.

To adapt to the high-salinity and high-sediment environment, the unmanned surface vehicle is equipped with the turbidity sensor to acquire real-time turbidity data. Time synchronization and space registration are performed on the low-frequency and high-frequency sonar data. Based on the acoustic attenuation model, the effective signal-to-noise ratio (SNR) for each frequency is calculated, enabling dynamic allocation of fusion weights for the low-frequency sonar and high-frequency sonar data. This ensures that low-frequency data dominates in highly turbid areas while preserving high-frequency details in less turbid regions.

In step A3, time synchronization and space registration are performed on water depth data of the sonars, and effective signal-to-noise ratios of the sonars are calculated based on the corrected theoretical received signal strengths of the sonars. In this embodiment, the effective signal-to-noise ratio of any sonar is calculated by the following formula:

$$S N R ( f ) = 10 {log}_{10} ( \frac{{P}_{signal} ( f )}{{P}_{noise} ( f )} ) ;$$

where SNR(f) represents the effective signal-to-noise ratio of the sonar with the acoustic wave frequency f, P_{signal}(f) represents the corrected theoretical received signal strength of the sonar with the acoustic wave frequency f, and Pₙₒᵢₛₑ(f) represents background noise energy of the sonar with the acoustic wave frequency f. Further, the background noise energy is calculated by the following formula:

$${P}_{noise} ( f ) = {P}_{env} ( f ) + {P}_{equip} ( f ) + {P}_{scatter} ( f ) ;$$

where Pₑₙᵥ(f) represents environmental noise; P_{equip}(f) represents device noise; and P_{scatter}(f) represents scattered noise.

In step A4, data fusion is performed on the water depth data of the sonars by using a dynamic weight fusion algorithm based on the effective signal-to-noise ratios of the sonars so as to obtain fused water depth data, where the water depth data is water depth data measured after calibrating velocities of the acoustic waves emitted by the sonars with a salinity, a water temperature, and a turbidity. In this embodiment, step A4 includes the following steps.

In step A41, for a sonar with an effective signal-to-noise ratio higher than a second threshold, a weight of the sonar is set to 0. In particular, when SNR<10 dB, the data is low-quality data which is eliminated directly.

In step A42, for sonar with the effective signal-to-noise ratio higher than the first threshold, the weight of the sonar is set to 1. When SNR>20 dB, the data is high-quality data which is directly used for fusion.

In step A43, for a sonar with an effective signal-to-noise ratio higher than a first threshold and lower than the second threshold, a weight of the sonar is calculated according to a proportion of the effective signal-to-noise ratio of the sonar in a sum of the effective signal-to-noise ratios of the sonars. Specifically, when the multi-frequency sonar group includes only one high-frequency sonar and one low-frequency sonar, and assuming that the effective signal-to-noise ratios of both sonars are between the first threshold and the second threshold, their weights are determined by the following formula:

$$\{ \begin{matrix}{w}_{low} = \frac{SNR ( {f}_{low} )}{SNR ( {f}_{low} ) + SNR ( {f}_{high} )} \\ {w}_{high} = \frac{SNR ( {f}_{high} )}{SNR ( {f}_{low} ) + SNR ( {f}_{high} )}\end{matrix}$$

where w_{low} represents a percentage of the effective signal-to-noise ratio of the low-frequency sonar relative to the total effective signal-to-noise ratio of both the low-frequency and high-frequency sonars; w_{high} represents a percentage of the effective signal-to-noise ratio of the high-frequency sonar relative to the total effective signal-to-noise ratio of both the low-frequency and high-frequency sonars; SNR(f_{low}) represents the effective signal-to-noise ratio of the low-frequency sonar; and SNR(f_{high}) represents the effective signal-to-noise ratio of the high-frequency sonar.

In step A44, the fused water depth data is calculated according to the weights of the sonars and the water depth data of the sonars. Specifically, when the multi-frequency sonar group includes only one high-frequency sonar and one low-frequency sonar, the fused water depth data is calculated by a formula below:

$${H}_{fused} = {w}_{low} \cdot {H}_{low} + {w}_{high} \cdot {H}_{high} ;$$

where H_{fused} represents the fused water depth data; w_{low} represents a weight of the low-frequency sonar; H_{low} represents the water depth data of the low-frequency sonar; w_{high} represents a weight of the high-frequency sonar; and H_{high} represents the water depth data of the high-frequency sonar. By combining the penetration capability of low frequencies with the detail resolution of high frequencies, high-accuracy and full-coverage underwater topographic data is generated.

Due to the higher acoustic velocity in saline water compared to freshwater, the default design velocity of approximately 1500 m/s for traditional unmanned surface vehicle equipment requires dynamic adjustment. Utilizing measurement data from the salinity-temperature-turbidity integrated sensor and the corrosion-resistant acoustic Doppler current profiler (ADCP) carried by the unmanned surface vehicle, the acoustic velocity in the environment where the unmanned surface vehicle is located can be calculated in real time, thereby improving the accuracy of sounding. Specifically, the velocities of the acoustic waves emitted by the sonars are calibrated by the following formula in this embodiment:

$$c = 1449.2 + 4.6 T - 0.055 {T}^{2} + 0.0003 {T}^{3} + ( 1.34 - 0.01 T ) ( S - 35 ) + 0.0 \; 16 D ;$$

where c represents a calibrated acoustic wave velocity of a sonar; T represents a water temperature measured at the position where the unmanned surface vehicle is located; S represents a salinity measured at the position where the unmanned surface vehicle is located; and D represents the water depth at the position where the unmanned surface vehicle is located. By feeding back the dynamic acoustic velocity c to the sounding sonar, the water depth calculation error is corrected so as to replace the traditional fixed acoustic velocity model.

In step A5, iterative optimization is performed on parameters of the acoustic attenuation model using an inversion method based on residual minimization according to residual values between actual received signal strengths and the theoretical received signal strengths of the sonars, thereby achieving dynamic parameter adjustment in a complex environment where the salinity and the sediment concentration change dynamically. A specific objective function is as follows:

$$α ( f ) = arg {min}_{α} ( {ε}^{2} ) ;$$

where ε represents a residual value between an actual received signal strength and a theoretical received signal strength.

The parameters of the acoustic attenuation model are re-calibrated to realize dynamic parameter adjustment, thereby optimizing the model. Thus, the measurement accuracy can be improved. Specifically, in this embodiment, step A5 includes the following steps.

Firstly, an initial attenuation coefficient α₀(f) is initialized, and is calculated by the following formula:

$${α}_{0} ( f ) = \frac{1}{2 D} ln ( \frac{{P}_{tx} \cdot R}{{P}_{signal} ( f ) \cdot {D}^{2}} ) .$$

In step A51, for any of the sonars, the theoretical received signal strength of the sonar is calculated according to a current acoustic attenuation coefficient.

The theoretical received signal strength P_{theory,i}(f) is calculated according to the current αᵢ(f), and is calculated by the following formula:

$${P}_{theory , i} ( f ) = {P}_{tx} \cdot \frac{{e}^{- 2 {α}_{i} \cdot D}}{{A}_{eff}} \cdot R .$$

In step A52, a received signal strength residual is calculated according to the actual received signal strength and the theoretical received signal strength of the sonar. Specifically, the received signal strength residual & is calculated by the following formula:

$${ε}_{i} = {P}_{meas} ( f ) - {P}_{theory , i} ( f ) ;$$

where Pₘₑₐₙₛ(f) represents the actual received signal strength.

Further, the partial derivative of the square of the residual ε with respect to α is calculated by the following formula:

$$\frac{\partial {ε}^{2}}{\partial α} = 2 ε \cdot \frac{\partial ε}{\partial α} ; where \frac{\partial ε}{\partial α} = - \frac{\partial {P}_{theory} ( f )}{\partial α} .$$

Further,

$$\frac{\partial {P}_{theory} ( f )}{\partial α} = \frac{{P}_{tx} \cdot R}{{A}_{eff}} \cdot \frac{\partial }{\partial α} ( {e}^{- 2 α D} ) = \frac{{P}_{tx} \cdot R}{{A}_{eff}} \cdot ( - 2 D \cdot {e}^{- 2 α D} ) = - 2 D \cdot {P}_{theory} ( f ) ,$$

and the following may be derived:

$$\frac{\partial {ε}^{2}}{\partial α} = 4 ε D {P}_{theory} ( f ) .$$

In step A53, the acoustic attenuation coefficient is iteratively optimized using a gradient descent method based on a partial derivative of the square of the received signal strength residual with respect to the acoustic attenuation coefficient until a difference between the current acoustic attenuation coefficient and a previous acoustic attenuation coefficient is smaller than a convergence threshold, thereby obtaining a target acoustic attenuation coefficient. The optimized acoustic attenuation coefficient is calculated by the following formula:

$${α}_{i + 1} ( f ) = {α}_{i} ( f ) - η \cdot \frac{\partial {ε}_{i}^{2}}{\partial \cdot {α}_{i} ( f )} = {α}_{i} ( f ) - η \cdot 4 ε D {P}_{theory} ( f ) ;$$

where η represents a learning rate (calibrated by an experiment) until |αᵢ₊₁(f)−αᵢ(f)|<the threshold.

In step A54, the parameters of the acoustic attenuation model are re-calibrated based on the target acoustic attenuation coefficient, thereby realizing dynamic updating of the acoustic attenuation model. Thus, the target acoustic attenuation coefficient is substituted into the acoustic attenuation model. The experimental parameters are re-calibrated through multiple iterations. The acoustic attenuation coefficient α(f) is optimized and inverted, thereby achieving dynamic parameter adjustment.

When the method of the present application is applied to measure the underwater topography, the acoustic velocity is dynamically corrected and calibrated with the data measured by the salinity-temperature-turbidity integrated sensor. Multi-frequency sonar measurements are employed and the acoustic attenuation model is utilized to establish the dynamic sonar weight allocation mechanism. This achieves the fusion of multi-frequency sonar data, resolving the conflict between penetration capability and resolution in highly turbid water. Furthermore, the acoustic attenuation coefficient is inverted from the residuals between the measured received signal strengths and the theoretical values and the parameters of the acoustic attenuation model are re-calibrated, enabling dynamic parameter adjustment and thereby optimizing the acoustic model and enhancing measurement accuracy.

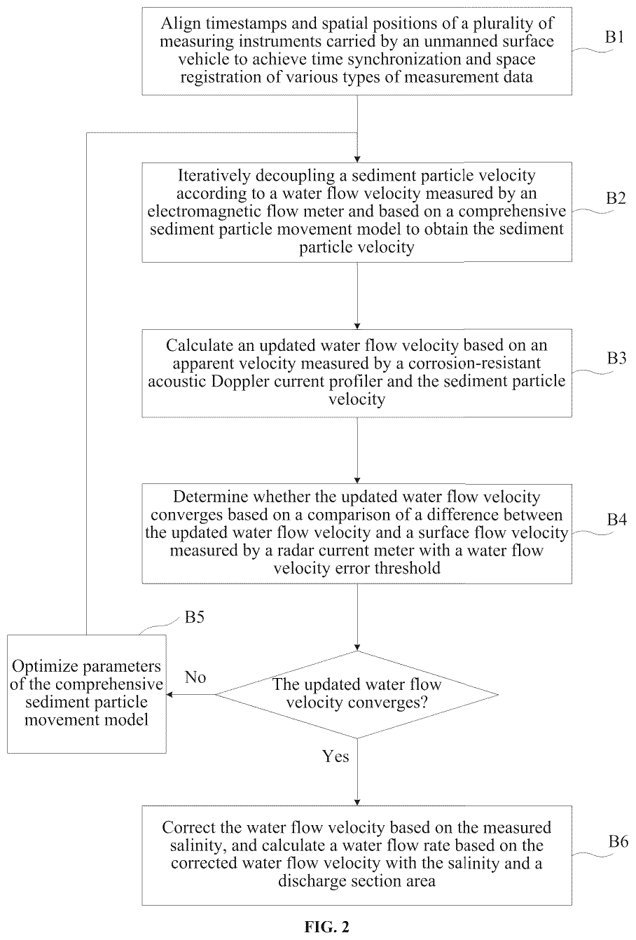

In another exemplary embodiment of the present application, a method for integrated measurement of hydrological elements in a high-salinity and high-sediment environment provided in the present application is used to accurately measure a water flow velocity and a flow rate in the high-salinity and high-sediment environment using an unmanned surface vehicle equipped with a plurality of measuring instruments. As shown in FIG. 2, the method for integrated measurement of hydrological elements in a high-salinity and high-sediment environment includes the following steps.

In step B1, timestamps and spatial positions of the plurality of measuring instruments carried by the unmanned surface vehicle are aligned to achieve time synchronization and space registration of various types of measurement data, where the measuring instruments carried by the unmanned surface vehicle include an electromagnetic flow meter, a radar current meter, a laser particle size analyzer, and a corrosion-resistant acoustic Doppler current profiler. First, data from various measuring instruments is acquired. For instance, the corrosion-resistant ADCP obtains the apparent velocity v_{ADCP} by measuring the Doppler frequency shift fa, so as to reflect the combined motion of particles and water flow. The electromagnetic flow meter outputs a value dependent solely on the water flow velocity v_{w} by measuring conductivity, with its measurement results refined through dynamic correction for salinity effects. The laser particle size analyzer provides sediment physical parameters by measuring the sediment concentration C and the sediment particle size d, thereby optimizing model coefficients. The surface radar current meter measures the surface flow velocity v_{radar} to constrain the surface water flow velocity and validate the decoupling results.

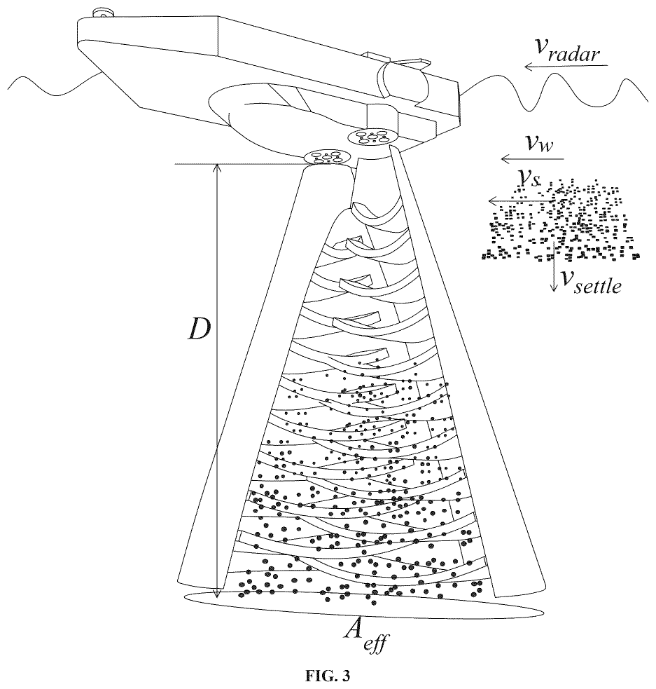

In step B2, a sediment particle velocity is iteratively decoupled according to a water flow velocity measured by the electromagnetic flow meter and based on a comprehensive sediment particle movement model to obtain the sediment particle velocity. Specifically, the schematic diagram of the unmanned surface vehicle measuring the water flow velocity and the flow rate in the high-salinity and high-sediment environment is shown in FIG. 3. This comprehensive sediment particle movement model integrates a settling velocity model with turbulent diffusion effects to enable comprehensive modeling of the sediment movement velocity. In this embodiment, the comprehensive sediment particle movement model is expressed as follows:

$${v}_{s} = {v}_{w} \cdot ( 1 - {e}^{- K \frac{{ρ}_{s} - {ρ}_{w}}{{ρ}_{w}} \cdot {d}^{0.5}} ) + {v}_{turb} ;$$

where vₛ represents a sediment particle velocity; v_{w} represents a water flow velocity; K represents a concentration attenuation coefficient; ρₛ and ρ_{w} represent densities of sediment and water, respectively; and d represents the sediment particle size.

The sediment settling velocity vₛₑₜₜₗₑ is calculated by the following formula:

$${v}_{settle} = \sqrt{\frac{4 gd ( {ρ}_{s} - {ρ}_{w} )}{3 {C}_{d} {ρ}_{w}}} ;$$

where ρₛ and ρ_{w} represent the densities of sediment and water, respectively; C_{d} represents a drag coefficient; g represents the gravitational acceleration; and d represents the sediment particle size.

Further, the particle velocity fluctuation v_{turb} is related to the turbulence intensity Iₜ, and is calculated by the following formula:

$${v}_{turb} = {I}_{t} \cdot {v}_{w} \cdot \sqrt{\frac{{ρ}_{w}}{{ρ}_{s}}} ;$$

where Iₜ represents the turbulence intensity. The comprehensive sediment particle movement model may be expressed as follows:

$${v}_{s}^{( n )} = {v}_{w}^{( n )} \cdot ( 1 - {e}^{- K \frac{{ρ}_{s} - {ρ}_{w}}{{ρ}_{w}} \cdot {d}^{0.5}} ) + {I}_{t} \cdot {v}_{w}^{( n )} \cdot \sqrt{\frac{{ρ}_{w}}{{ρ}_{s}}} ;$$

where

$${v}_{s}^{( n )}$$

represents the sediment particle velocity during the n-th iterative decoupling; and

$${v}_{w}^{( n )}$$

represents une water now velocity during the n-th iterative decoupling.

The initial water flow velocity

$${v}_{w}^{( 0 )} = {v}_{E M}$$

is obtained by the electromagnetic flow meter, and the sediment concentration C and the particle size d are input by the laser particle size analyzer. The sediment particle velocity

$${v}_{s}^{( n )}$$

is iteratively decoupled based on the comprehensive sediment particle movement model to obtain the sediment particle velocity.

In step B3, an updated water flow velocity is calculated based on an apparent velocity measured by the corrosion-resistant acoustic Doppler current profiler and the sediment particle velocity. The updated water flow velocity is calculated by a formula as follows:

$${v}_{w}^{( n + 1 )} = {v}_{A D C P} - {v}_{s}^{( n )} ;$$

where

$${v}_{w}^{( n + 1 )}$$

represents the updated water flow velocity; and v_{ADCP} represents the apparent velocity measured by the corrosion-resistant acoustic Doppler current profiler.

In step B4, whether the updated water flow velocity converges is determined based on a comparison of a difference between the updated water flow velocity and a surface flow velocity measured by the radar current meter with a water flow velocity error threshold. If the updated water flow velocity does not converge, step B5 is performed; and if the updated water flow velocity converges, step B6 is performed. Specifically, when

$$\vert {v}_{w}^{( n + 1 )} - {v}_{radar} \vert < 0.01 m / s ,$$

the measurement accuracy is on the centimeter-level, and the updated water flow velocity converges.

In step B5, the parameters of the comprehensive sediment particle movement model are optimized, and the step jumps to step B2.

In step B6, the water flow velocity is corrected based on the measured salinity, and a water flow rate is calculated based on the corrected water flow velocity with the salinity and a discharge section area. The water flow velocity is corrected by the following formula:

$${v}_{E M , c o r rected} = {v}_{E M} \cdot ( 1 + β \cdot ( S - {S}_{0} ) ) ;$$

where v_{EM,corrected} represents the corrected water flow velocity with the salinity; v_{EM} represents the water flow velocity measured by the electromagnetic flow meter; β represents a salinity sensitivity coefficient; S represents the measured salinity; and S₀ represents a calibrated salinity.

According to the solution provided in this embodiment of the present application, the comprehensive sediment particle movement model is established by simultaneously considering turbulent dynamics, sediment kinematics, and salinity-induced electrochemical effects, thereby covering all elements in complex environments. The decoupling results are validated using the radar current meter and the acoustic Doppler current profiler. This triggers anomaly detection and parameter re-calibration, and a closed-loop feedback mechanism is formed to enhance the measurement accuracy of the water flow velocity and the flow rate.

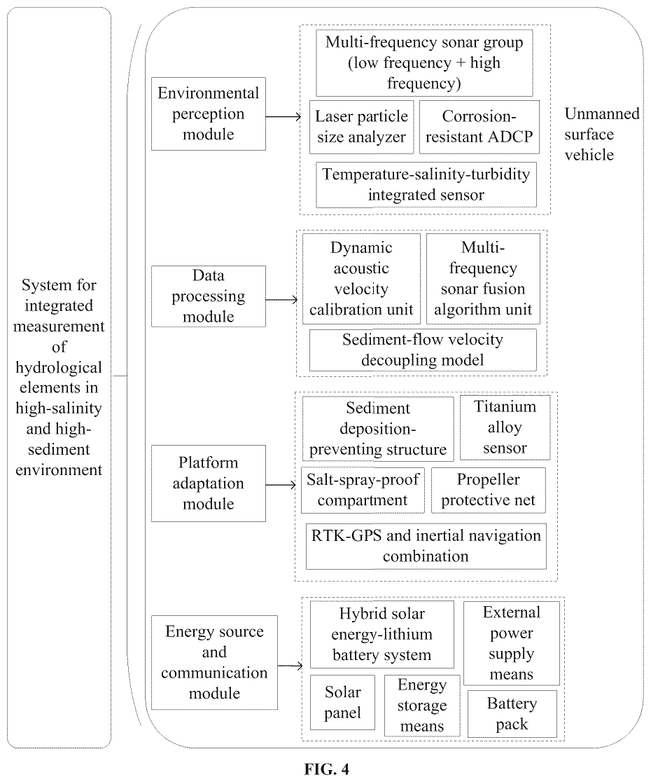

Based on the same inventive concept, an embodiment of the present application further provides a system for integrated measurement of hydrological elements in a high-salinity and high-sediment environment. The solutions provided by the system to problems are similar to those described above with respect to the method. In an exemplary embodiment, as shown in FIG. 4, provided is a system for integrated measurement of hydrological elements in a high-salinity and high-sediment environment, which has an unmanned surface vehicle of a sediment deposition-preventing structure as a main body and includes: a platform adaptation module that is configured to provide hardware support for the unmanned surface vehicle and includes a titanium alloy sensor housing, a salt-spray-proof electronic compartment, a propeller equipped with a protective net, and a positioning unit; an environmental perception module including a plurality of measuring instruments carried by the unmanned surface vehicle; a data processing module configured to implement the method for integrated measurement of hydrological elements in a high-salinity and high-sediment environment as described above; and an energy source and communication module configured to provide energy and power for the unmanned surface vehicle and provide support for communication between modules.

In an optional embodiment, the environmental perception module is composed of a multi-frequency sonar group (28 kHz+200 kHz), a salinity-temperature-turbidity sensor, a laser particle size analyzer (LISST), and a corrosion-resistant ADCP, and is configured to provide and send accurate data to the data processing module according to the environmental data collected by the unmanned surface vehicle.

The data processing module is composed of a dynamic acoustic velocity calibration unit, a multi-frequency sonar fusion algorithm unit, and a sediment-flow velocity decoupling model, and is configured to accurately process the data and transmit the unified environmental data to a remote platform via the energy source and communication module.

In an optional embodiment, the energy source and communication module is composed of a hybrid solar energy-lithium battery system and a redundant dual-link LoRa/4G communication system.

Of course, the architecture shown in FIG. 4 is only exemplary, and one or at least two assemblies in the system shown in FIG. 4 may be omitted according to actual needs when different functions are achieved.

The technical characteristics of the above embodiments can be employed in arbitrary combinations. To provide a concise description of these embodiments, all possible combinations of all the technical characteristics of the above embodiments may not be described. However, these combinations of the technical characteristics should be construed as falling within the scope defined by the specification as long as no contradiction occurs.

Several examples are used herein for illustration of the principles and implementations of the present application. The description of the foregoing examples is used to help illustrate the method of the present application and the core principles thereof. In addition, those of ordinary skill in the art can make various modifications in terms of specific implementations and scope of application in accordance with the teachings of the present application. In conclusion, the content of the present specification shall not be construed as a limitation to the present application.

What is claimed is:

1. A method for integrated measurement of hydrological elements in a high-salinity and high-sediment environment, wherein the method is used to accurately measure an underwater topography in the high-salinity and high-sediment environment using an unmanned surface vehicle equipped with a plurality of measuring instruments and comprises:
establishing an acoustic attenuation model for a laser particle size analyzer and a multi-frequency sonar group carried by the unmanned surface vehicle, wherein the multi-frequency sonar group comprises a plurality of sonars with different frequencies; and the acoustic attenuation model is configured to characterize respective attenuations of acoustic waves emitted by the sonars with different frequencies at different sediment concentrations;
correcting theoretical received signal strengths of the sonars using the acoustic attenuation model and an acoustic wave propagation distance, thereby obtaining corrected theoretical received signal strengths of the sonars;
performing time synchronization and space registration on water depth data of the sonars, and calculating effective signal-to-noise ratios of the sonars based on the corrected theoretical received signal strengths of the sonars;
performing data fusion on the water depth data of the sonars by using a dynamic weight fusion algorithm based on the effective signal-to-noise ratios of the sonars so as to obtain fused water depth data, wherein the water depth data is water depth data measured after calibrating velocities of the acoustic waves emitted by the sonars with a salinity, a water temperature, and a turbidity; and
performing iterative optimization on parameters of the acoustic attenuation model using an inversion method based on residual minimization according to residual values between actual received signal strengths and the theoretical received signal strengths of the sonars, thereby achieving dynamic parameter adjustment in a complex environment where the salinity and the sediment concentration change dynamically.

2. The method for integrated measurement of hydrological elements in a high-salinity and high-sediment environment according to claim 1, wherein the acoustic attenuation model is expressed as follows:
$$α ( f ) = k \cdot {C}^{m} \cdot {f}^{n} \cdot {d}^{p} ;$$
wherein α(f) represents an acoustic attenuation coefficient of a sonar with an acoustic wave frequency f, k represents a water attenuation proportion coefficient; C represents a sediment concentration; m represents a sediment concentration index; f represents an acoustic wave frequency; n represents a frequency index; d represents a sediment particle size; and p represents a particle size index;
the theoretical received signal strength of any of the sonars is corrected by a formula below:
$${P}_{s i g n a l} ( f ) = {P}_{tx} \cdot \frac{{e}^{- 2 α ( f , C , d ) \cdot D}}{{A}_{e f f}} \cdot R ;$$
wherein P_{signal}(f) represents the corrected theoretical received signal strength of the sonar with the acoustic wave frequency f, Pₜₓ represents a sonar transmission power; e represents a natural constant; D represents a water depth at a position where the unmanned surface vehicle is located; A_{eff} represents an effective irradiation area of a sonar wave beam; and R represents a riverbed reflection coefficient at the position where the unmanned surface vehicle is located.

3. The method for integrated measurement of hydrological elements in a high-salinity and high-sediment environment according to claim 1, wherein the performing data fusion on the water depth data of the sonars by using a dynamic weight fusion algorithm based on the effective signal-to-noise ratios of the sonars so as to obtain fused water depth data comprises:
for a sonar with an effective signal-to-noise ratio higher than a second threshold, setting a weight of the sonar to 0;
for the sonar with the effective signal-to-noise ratio higher than the first threshold, setting the weight of the sonar to 1;
for a sonar with an effective signal-to-noise ratio higher than a first threshold and lower than the second threshold, calculating a weight of the sonar according to a proportion of the effective signal-to-noise ratio of the sonar in a sum of the effective signal-to-noise ratios of the sonars; and
calculating the fused water depth data according to the weights of the sonars and the water depth data of the sonars.

4. The method for integrated measurement of hydrological elements in a high-salinity and high-sediment environment according to claim 3, wherein the effective signal-to-noise ratio of any of the sonars is calculated by a formula below:
$$S N R ( f ) = 10 {log}_{10} ( \frac{{P}_{signal} ( f )}{{P}_{n o i s e} ( f )} ) ;$$
wherein SNR(f) represents the effective signal-to-noise ratio of the sonar with the acoustic wave frequency f, P_{signal}(f) represents the corrected theoretical received signal strength of the sonar with the acoustic wave frequency f, and Pₙₒᵢₛₑ(f) represents background noise energy of the sonar with the acoustic wave frequency f,
when the multi-frequency sonar group comprises only one high-frequency sonar and one low-frequency sonar, the fused water depth data is calculated by a formula below:
$${H}_{f u s e d} = {w}_{l o w} \cdot {H}_{l o w} + {w}_{h i g h} \cdot {H}_{h i g h} ;$$
wherein H_{fused} represents the fused water depth data; w_{low} represents a weight of the low-frequency sonar; H_{low} represents the water depth data of the low-frequency sonar; w_{high} represents a weight of the high-frequency sonar; and H_{high} represents the water depth data of the high-frequency sonar.

5. The method for integrated measurement of hydrological elements in a high-salinity and high-sediment environment according to claim 1, wherein the performing iterative optimization on parameters of the acoustic attenuation model using an inversion method based on residual minimization according to residual values between actual received signal strengths and the theoretical received signal strengths of the sonars comprises:
for any of the sonars, calculating the theoretical received signal strength of the sonar according to a current acoustic attenuation coefficient;
calculating a received signal strength residual according to the actual received signal strength and the theoretical received signal strength of the sonar;
iteratively optimizing the acoustic attenuation coefficient using a gradient descent method based on a partial derivative of the square of the received signal strength residual with respect to the acoustic attenuation coefficient until a difference between the current acoustic attenuation coefficient and a previous acoustic attenuation coefficient is smaller than a convergence threshold, thereby obtaining a target acoustic attenuation coefficient; and
re-calibrating the parameters of the acoustic attenuation model based on the target acoustic attenuation coefficient, thereby realizing dynamic updating of the acoustic attenuation model.

6. The method for integrated measurement of hydrological elements in a high-salinity and high-sediment environment according to claim 1, wherein the velocities of the acoustic waves emitted by the sonars are calibrated by a formula below:
$$c = 1449.2 + 4.6 T - 0.055 {T}^{2} + 0.0003 {T}^{3} + ( 1.34 - 0.01 T ) ( S - 35 ) + 0.0 \; 16 D ;$$
wherein c represents a calibrated acoustic wave velocity of a sonar; T represents a water temperature measured at the position where the unmanned surface vehicle is located; S represents a salinity measured at the position where the unmanned surface vehicle is located; and
D represents the water depth at the position where the unmanned surface vehicle is located.

7. A method for integrated measurement of hydrological elements in a high-salinity and high-sediment environment, wherein the method is used to accurately measure a water flow velocity and a flow rate in the high-salinity and high-sediment environment using an unmanned surface vehicle equipped with a plurality of measuring instruments and comprises:
aligning timestamps and spatial positions of the plurality of measuring instruments carried by the unmanned surface vehicle to achieve time synchronization and space registration of various types of measurement data, wherein the measuring instruments carried by the unmanned surface vehicle comprise an electromagnetic flow meter, a radar current meter, a laser particle size analyzer, and a corrosion-resistant acoustic Doppler current profiler;
iteratively decoupling a sediment particle velocity according to a water flow velocity measured by the electromagnetic flow meter and based on a comprehensive sediment particle movement model to obtain the sediment particle velocity;
calculating an updated water flow velocity based on an apparent velocity measured by the corrosion-resistant acoustic Doppler current profiler and the sediment particle velocity;
determining whether the updated water flow velocity converges based on a comparison of a difference between the updated water flow velocity and a surface flow velocity measured by the radar current meter with a water flow velocity error threshold;
if the updated water flow velocity does not converge, optimizing parameters of the comprehensive sediment particle movement model, and iteratively decoupling the sediment particle velocity according to the water flow velocity measured by the electromagnetic flow meter and based on the comprehensive sediment particle movement model to obtain the sediment particle velocity; and
if the updated water flow velocity converges, correcting the water flow velocity based on the measured salinity, and calculating a water flow rate based on the corrected water flow velocity with the salinity and a discharge section area.

8. The method for integrated measurement of hydrological elements in a high-salinity and high-sediment environment according to claim 7, wherein the comprehensive sediment particle movement model is expressed as follows:
$${v}_{s}^{( n )} = {v}_{w}^{( n )} \cdot ( 1 - {e}^{- K \frac{{ρ}_{s} - {ρ}_{w}}{{ρ}_{w}} {d}^{0.5}} ) + {I}_{t} \cdot {v}_{w}^{( n )} \cdot \sqrt{\frac{{ρ}_{w}}{{ρ}_{s}}} ;$$
wherein
$${v}_{s}^{( n )}$$
represents a sediment particle velocity during n-th iterative decoupling;
$${v}_{w}^{( n )}$$
represents a water flow velocity during the n-th iterative decoupling; K represents a concentration attenuation coefficient; ρₛ and ρ_{w} represent densities of sediment and water, respectively; d represents the sediment particle size; and Iₜ represents a turbulence intensity; and
the updated water flow velocity is calculated by a formula as follows:
$${v}_{w}^{( n + 1 )} = {v}_{ADCP} - {v}_{s}^{( n )} ;$$
wherein
$${v}_{w}^{( n + 1 )}$$
represents the updated water flow velocity; and v_{ADCP} represents the apparent velocity measured by the corrosion-resistant acoustic Doppler current profiler.

9. The method for integrated measurement of hydrological elements in a high-salinity and high-sediment environment according to claim 7, wherein the water flow velocity is corrected by a formula as follows:
$${v}_{EM , corrected} = {v}_{EM} \cdot ( 1 + β \cdot ( S - {S}_{0} ) ) ;$$
wherein v_{EM,corrected} represents the corrected water flow velocity with the salinity; v_{EM} represents the water flow velocity measured by the electromagnetic flow meter; β represents a salinity sensitivity coefficient; S represents the measured salinity; and S₀ represents a calibrated salinity.

10. A system for integrated measurement of hydrological elements in a high-salinity and high-sediment environment, wherein the system takes an unmanned surface vehicle of a sediment deposition-preventing structure as a main body and comprises: a platform adaptation module that is configured to provide hardware support for the unmanned surface vehicle and comprises a titanium alloy sensor housing, a salt-spray-proof electronic compartment, a propeller equipped with a protective net, and a positioning unit; an environmental perception module comprising a plurality of measuring instruments carried by the unmanned surface vehicle; a data processing module configured to implement the method for integrated measurement of hydrological elements in a high-salinity and high-sediment environment according to claim 1; and an energy source and communication module configured to provide energy and power for the unmanned surface vehicle and provide support for communication between modules.

11. The system according to claim 10, wherein the acoustic attenuation model is expressed as follows:
$$α ( f ) = k \cdot {C}^{m} \cdot {f}^{n} \cdot {d}^{p} ;$$
wherein α(f) represents an acoustic attenuation coefficient of a sonar with an acoustic wave frequency f, k represents a water attenuation proportion coefficient; C represents a sediment concentration; m represents a sediment concentration index; f represents an acoustic wave frequency; n represents a frequency index; d represents a sediment particle size; and p represents a particle size index;
the theoretical received signal strength of any of the sonars is corrected by a formula below:
$${P}_{signal} ( f ) = {P}_{tx} \cdot \frac{{e}^{- 2 α ( f , C , d ) \cdot D}}{{A}_{eff}} \cdot R ;$$
wherein P_{signal}(f) represents the corrected theoretical received signal strength of the sonar with the acoustic wave frequency f, Pₜₓ represents a sonar transmission power; e represents a natural constant; D represents a water depth at a position where the unmanned surface vehicle is located; A_{eff} represents an effective irradiation area of a sonar wave beam; and R represents a riverbed reflection coefficient at the position where the unmanned surface vehicle is located.

12. The system according to claim 10, wherein the performing data fusion on the water depth data of the sonars by using a dynamic weight fusion algorithm based on the effective signal-to-noise ratios of the sonars so as to obtain fused water depth data comprises:
for a sonar with an effective signal-to-noise ratio higher than a second threshold, setting a weight of the sonar to 0;
for the sonar with the effective signal-to-noise ratio higher than the first threshold, setting the weight of the sonar to 1;
for a sonar with an effective signal-to-noise ratio higher than a first threshold and lower than the second threshold, calculating a weight of the sonar according to a proportion of the effective signal-to-noise ratio of the sonar in a sum of the effective signal-to-noise ratios of the sonars; and
calculating the fused water depth data according to the weights of the sonars and the water depth data of the sonars.

13. The system according to claim 12, wherein the effective signal-to-noise ratio of any of the sonars is calculated by a formula below:
$$SNR ( f ) = 10 {log}_{10} ( \frac{{P}_{signal} ( f )}{{P}_{noise} ( f )} ) ;$$
wherein SNR(f) represents the effective signal-to-noise ratio of the sonar with the acoustic wave frequency f, P_{signal}(f) represents the corrected theoretical received signal strength of the sonar with the acoustic wave frequency f, and Pₙₒᵢₛₑ(f) represents background noise energy of the sonar with the acoustic wave frequency f,
when the multi-frequency sonar group comprises only one high-frequency sonar and one low-frequency sonar, the fused water depth data is calculated by a formula below:
$${H}_{fused} = {w}_{low} \cdot {H}_{low} + {w}_{high} \cdot {H}_{high} ;$$
wherein H_{fused} represents the fused water depth data; w_{low} represents a weight of the low-frequency sonar; H_{low} represents the water depth data of the low-frequency sonar; w_{high} represents a weight of the high-frequency sonar; and H_{high} represents the water depth data of the high-frequency sonar.

14. The system according to claim 10, wherein the performing iterative optimization on parameters of the acoustic attenuation model using an inversion method based on residual minimization according to residual values between actual received signal strengths and the theoretical received signal strengths of the sonars comprises:
for any of the sonars, calculating the theoretical received signal strength of the sonar according to a current acoustic attenuation coefficient;
calculating a received signal strength residual according to the actual received signal strength and the theoretical received signal strength of the sonar;
iteratively optimizing the acoustic attenuation coefficient using a gradient descent method based on a partial derivative of the square of the received signal strength residual with respect to the acoustic attenuation coefficient until a difference between the current acoustic attenuation coefficient and a previous acoustic attenuation coefficient is smaller than a convergence threshold, thereby obtaining a target acoustic attenuation coefficient; and
re-calibrating the parameters of the acoustic attenuation model based on the target acoustic attenuation coefficient, thereby realizing dynamic updating of the acoustic attenuation model.

15. The system according to claim 10, wherein the velocities of the acoustic waves emitted by the sonars are calibrated by a formula below:
$$c = 1449.2 + 4 \text{.6} T - 0.055 {T}^{2} + 0.0003 {T}^{3} + ( 1. 34 - 0.01 T ) ( S - 35 ) + 0.0 \; 16 D ;$$
wherein c represents a calibrated acoustic wave velocity of a sonar; T represents a water temperature measured at the position where the unmanned surface vehicle is located; S represents a salinity measured at the position where the unmanned surface vehicle is located; and D represents the water depth at the position where the unmanned surface vehicle is located.

16. A system for integrated measurement of hydrological elements in a high-salinity and high-sediment environment, wherein the system takes an unmanned surface vehicle of a sediment deposition-preventing structure as a main body and comprises: a platform adaptation module that is configured to provide hardware support for the unmanned surface vehicle and comprises a titanium alloy sensor housing, a salt-spray-proof electronic compartment, a propeller equipped with a protective net, and a positioning unit; an environmental perception module comprising a plurality of measuring instruments carried by the unmanned surface vehicle; a data processing module configured to implement the method for integrated measurement of hydrological elements in a high-salinity and high-sediment environment according to claim 7; and an energy source and communication module configured to provide energy and power for the unmanned surface vehicle and provide support for communication between modules.

17. The system according to claim 16, wherein the comprehensive sediment particle movement model is expressed as follows:
$${v}_{s}^{( n )} = {v}_{w}^{( n )} \cdot ( 1 - {e}^{- K \cdot \frac{{ρ}_{s} - {ρ}_{w}}{{ρ}_{w}} \cdot {d}^{0.5}} ) + {I}_{t} \cdot {v}_{w}^{( n )} \cdot \sqrt{\frac{{ρ}_{w}}{{ρ}_{s}}} ;$$
wherein
$${v}_{s}^{( n )}$$
represents a sediment particle velocity during n-th iterative decoupling;
$${v}_{w}^{( n )}$$
represents a water flow velocity during the n-th iterative decoupling; K represents a concentration attenuation coefficient; ρₛ and ρ_{w} represent densities of sediment and water, respectively; d represents the sediment particle size; and Iₜ represents a turbulence intensity; and
the updated water flow velocity is calculated by a formula as follows:
$${v}_{w}^{( n + 1 )} = {v}_{ADCP} - {v}_{s}^{( n )} ;$$
wherein
$${v}_{w}^{( n + 1 )}$$
represents the updated water flow velocity; and v_{ADCP} represents the apparent velocity measured by the corrosion-resistant acoustic Doppler current profiler.

18. The system according to claim 16, wherein the water flow velocity is corrected by a formula as follows:
$${v}_{EM , corrected} = {v}_{EM} \cdot ( 1 + β \cdot ( S - {S}_{0} ) ) ;$$
wherein v_{EM,corrected} represents the corrected water flow velocity with the salinity; v_{EM} represents the water flow velocity measured by the electromagnetic flow meter; β represents a salinity sensitivity coefficient; S represents the measured salinity; and S₀ represents a calibrated salinity.
